(19) United States
(12) Patent Application Publication
(10) Pub. No.: US 2026/0233671 A1
(43) Pub. Date: Aug. 13, 2026

(54) Method for Warning Lighting on a Bicycle and Warning Light Device for a Bicycle

(71) Applicant: Canyon Bicycles GmbH, Koblenz (DE)

(72) Inventor: Victor Fernando Casas Melo, Koblenz (DE)

(21) Appl. No.: 19/533,525

(22) Filed: Feb. 9, 2026

(30) Foreign Application Priority Data
Feb. 10, 2025 (DE) 102025104736.7

(51) Int. Cl. B60Q 9/00; B60Q 1/00; B60Q 1/50; B62J 6/26; H05B 47/12; H05B 47/125; H05B 47/13

(52) U.S. Cl. CPC B60Q 9/008; B60Q 1/0023; B60Q 1/535; B62J 6/26; H05B 47/12; H05B 47/125; H05B 47/13

(57) ABSTRACT

A method for warning lighting on a bicycle, comprising the steps of detecting a position of a vehicle traveling behind the bicycle relative to the bicycle by means of a detection device arranged on the bicycle, and changing the intensity of a rearward-facing lighting on the bicycle based on the detected position. The invention further comprises a system for data processing, a warning light device for a bicycle, a bicycle, a computer program and a computer-readable storage medium.

### CROSS-REFERENCE TO RELATED APPLICATION

This application claims priority to German Patent Application No. 102025104736.7 filed Feb. 10, 2025, the disclosure of which is hereby incorporated by reference in its entirety.

### BACKGROUND OF THE INVENTION

### Field of the Invention

The invention relates to a method for warning lighting on a bicycle and a warning light device for a bicycle.

### Description of Related Art

Bicycles are particularly vulnerable in road traffic as they are narrow, often difficult to see and unprotected. It is particularly dangerous when vehicles are coming from behind and overtaking, as they often pass cyclists too closely or underestimate the velocity and dynamics of the bicycle. This can lead to critical situations such as rear-end collisions, side collisions or dangerous swerving, especially in poor visibility conditions or when overtaking vehicles are traveling at high speeds.

In order to increase the visibility and safety of cyclists in road traffic, there are approaches to increase the visibility and safety of cyclists in road traffic. In particular, static rear lights or simple flashing systems are used, which only indicate the presence of the bicycle. One problem with flashing warning lights, for example, is that they are not approved under the German Road Traffic Licensing Regulation (StVZO).

### SUMMARY OF THE INVENTION

The object of the invention is to provide a method for warning lighting on a bicycle and a warning light device for a bicycle, wherein the visibility of cyclists in road traffic is improved.

According to the invention, the object is achieved by a method for warning lighting on a bicycle and a warning light device for a bicycle as described herein.

The method according to the invention for warning lighting on a bicycle is in particular a method for emitting a warning light on the bicycle to other road users, preferably to motor vehicles, particularly preferably to motor vehicles traveling behind the bicycle. The method comprises the step of detecting a position, in particular a relative position, and in particular a change in position of a vehicle traveling behind the bicycle relative to the bicycle by means of a detection device arranged on the bicycle. Furthermore, the method has the additional step of changing the intensity of a rearward-facing lighting on the bicycle, in particular the rear lamp of the bicycle, based on the detected position. In particular, the vehicle driving behind the bicycle is the closest vehicle to the bicycle. If several vehicles are driving behind the bicycle, the position of the next vehicle behind the bicycle is detected. In particular, the vehicle is a motor vehicle, e.g. a passenger car or truck. Preferably, the method and/or the detection device is limited to the detection of motor vehicles. To provide lighting, the bicycle has a lamp, preferably a rear lamp. For example, the lamp can have at least one LED. The lamp preferably emits red light. The lamp preferably emits a rear light. In particular, the lamp has a dimming function for emitting light in different intensities. The output of different intensities, in particular the dimming function, can be achieved, for example, by regulating the voltage, adjusting the current intensity, using pulse width modulation (PWM) and/or controlling the current flow via phase-angle control and/or phase cutting control. Alternatively or additionally, individual illuminants can be activated or deactivated in a lamp with several illuminants, e.g. several LEDs.

It is preferred that when the intensity is changed, the lighting is changed from a bright to a darker lighting intensity or from a dark to a brighter lighting intensity. In particular, at least two lighting intensities I₁ und I₂ of the lighting are thus implemented, with the light emitted by the lighting having a lower intensity at I₁ than at I₂. I₁ therefore corresponds in particular to a dark light mode and I₂ corresponds to a bright light mode. Preferably, when the intensity of the lighting is changed, the amount of light and/or the luminous flux (in lm) is changed, wherein it is preferred that the amount of light and/or the luminous flux is ≠0, preferably in all change states. The change in the intensity of the lighting is in particular a one-off change in intensity, in particular a one-off change in intensity for at least one defined position state, e.g. distance state, of the detected position. Additionally or alternatively, it is particularly possible for the lighting to pulsate when the intensity of the lighting is changed. In particular, the pulsation is a continuous change in the intensity of the bicycle's rearward-facing lighting. In particular, the lighting illuminates in the brighter and darker lighting states and/or during the entire pulsing process, so that a quantity of light is always emitted. By changing the lighting intensity, a warning function particularly compliant with the StVZO is implemented, preferably without flashing.

It is preferred that the detection device detects the velocity vᵥₑₕ of the vehicle, the velocity v_{bike} of the bicycle and/or a relative velocity vᵣₑₗ between the bicycle and the vehicle. Particularly preferably, a change in vᵥₑₕ, v_{bike} and/or vᵣₑₗ is detected.

It is preferred that the detection device detects the relative distance dᵣₑₗ, in particular to the rear, of vehicle and bicycle and preferably a change in distance. It is particularly preferable to continuously detect the change in distance. In particular, it is possible for the detection device to additionally or alternatively detect the velocity of the vehicle, preferably relative to the bicycle. In the context of the present disclosure, the detected position thus comprises in particular the relative distance dᵣₑₗ and/or the relative velocity vᵣₑₗ.

It is preferred that the intensity of the lighting is changed when a distance between the vehicle and the bicycle is detected that is smaller than a normal braking distance of the vehicle. In particular, when a change is detected between

$${d}_{rel} \geq {s}_{norm} + {b}_{norm} , and \qquad state i$$

$${d}_{rel} < {s}_{norm} + {b}_{norm} , \qquad state ii$$

there is a change in the intensity of the lighting, wherein
sₙₒᵣₘ is a normal braking distance of the vehicle, and
bₙₒᵣₘ is a safety buffer for the normal braking distance of the vehicle.
   This change corresponds in particular to a defined position state, so that it is preferable for a change, preferably every change, to result in a one-off change in the intensity of the lighting. Preferably, the intensity of the lighting changes with a change, in particular every change, from state i. to state ii. and/or vice versa. When changing from state i. to state ii. the lighting intensity in particular changes from I₁ tol₂. When changing from state ii. to state i. the lighting intensity in particular changes from I₂ to I₁. If dᵣₑₗ≥sₙₒᵣₘ+bₙₒᵣₘ is detected, the intensity is set to I₁ in particular. If dᵣₑₗ<sₙₒᵣₘ+bₙₒᵣₘ is detected, the intensity is set to I₂ in particular. The normal braking distance sₙₒᵣₘ, in particular in m, is e.g:
sₙₒᵣₘ=(velocity vᵥₑₕ in particular relative velocity vᵣₑₗ of the vehicle in km/h:10)×(velocity vᵥₑₕ in particular relative velocity vᵣₑₗ of the vehicle in km/h:10). The safety buffer bₙₒᵣₘ can, for example, be a fixed value, in particular in m. In particular, it is also possible that bₙₒᵣₘ is its factor of sₙₒᵣₘ, e.g.
bₙₒᵣₘ=sₙₒᵣₘ*x, wherein
x is 200% to 1%, preferably 100% to 5%, particularly preferably 50% to 10%. bₙₒᵣₘ can be 0, for example.
   Alternatively, bₙₒᵣₘ can be replaced by the reaction path in particular. Given a reaction time of 1 second, the reaction path is e.g: (velocity vᵥₑₕ in particular relative velocity vᵣₑₗ of the vehicle in km/h:10)*3.

It is preferred that the intensity of the lighting is changed when a distance between the vehicle and the bicycle is detected that is smaller than a hazard braking distance of the vehicle. In particular, when a change is detected between

$${s}_{norm} + {b}_{norm} > {d}_{rel} \geq {s}_{hazard} + {b}_{hazard} , and \qquad state iii$$

$${d}_{rel} < {s}_{hazard} + {b}_{hazard} , \qquad state iv$$

there is a change in the intensity of the lighting, wherein
s_{hazard} is a hazard braking distance of the vehicle, and
b_{hazard} is a safety buffer for the normal braking distance of the vehicle.
   Preferably, the intensity of the lighting changes with a change, in particular every change, from state iii. to state iv. and/or vice versa. If dᵣₑₗ<sₙₒᵣₘ+bₙₒᵣₘ and dᵣₑₗ≥s_{hazard}+b_{hazard} is detected, the intensity is set to I₂ in particular. Preferably, the following applies: s_{hazard}+b_{hazard}<sₙₒᵣₘ+bₙₒᵣₘ. For example the following applies: b_{hazard}<bₙₒᵣₘ. The hazard braking distance s_{hazard}, in particular in m, is e.g:
s_{hazard}=((velocity vᵥₑₕ in particular relative velocity vᵣₑₗ of the vehicle in km/h:10)×(velocity vᵥₑₕ in particular relative velocity vᵣₑₗ of the vehicle in km/h:10))/2. The safety buffer b_{hazard} can, for example, be a fixed value, in particular in m. In particular, it is also possible that b_{hazard} is its factor of s_{hazard}, e.g.
b_{hazard}=s_{hazard}*x, wherein
x is 200% to 1%, preferably 100% to 5%, particularly preferably 50% to 10%. b_{hazard} can be 0, for example.
   Alternatively, bₙₒᵣₘ can be replaced by the reaction path in particular. Given a reaction time of 1 second, the reaction path is e.g: (velocity vᵥₑₕ in particular relative velocity vᵣₑₗ of the vehicle in km/h:10)*3.

Alternatively or in addition to using the velocity vᵥₑₕ, in particular the relative velocity vᵣₑₗ, a potential time to collision ttc can be used to set the lighting. The ttc value for setting the intensity can be calculated in particular with the bₙₒᵣₘ or/and with the b_{hazard} value and the relative velocity vᵣₑₗ. For example the following applies:

$$ttc = {d}_{rel} / {v}_{rel} ,$$

$${ttc}_{bnorm} = {b}_{norm /} {v}_{rel} ,$$

$${ttc}_{bnorm} = {b}_{norm /} {v}_{rel} ,$$

$$ttc \geq {ttc}_{bnorm} , \qquad state i$$

$$ttc < {ttc}_{bnorm} , \qquad state ii$$

$${ttc}_{bnorm} > ttc \geq {ttc}_{bhazard} , and / or \qquad state iii$$

$$ttc < {ttc}_{bhazard} . \qquad state iv$$

It is preferable that the intensity of the lighting changes when the bicycle brakes (x_{break}=true). In particular, it is possible that this change in the intensity of the lighting only takes place for the duration of the braking process and thus, in particular, a reset to the previous intensity then takes place. This change in intensity, which is limited to the braking process, is implemented in particular if the initial intensity before the braking process corresponds to the darker intensity I₁. In addition or alternatively, it is particularly possible that this change in the intensity of the lighting only takes place for a short time, in particular for a predefined time Δt. Δt is preferably between 5 s and 0.01 s, particularly preferably between 1 s and 0.05 s. This change in intensity, which is limited to a predefined time, is implemented in particular if the initial intensity before the braking process corresponds to the brighter intensity I₂. The change therefore particularly involves a short-term change, preferably from I₂ to I₁. After the time-limited change, the intensity is reset to the initial intensity, in particular. In other words, the lighting is darkened for a short time. The brief darkening of the light, in particular the subsequent brighter illumination, once again implements a warning function with regard to braking.

It is preferred that during a detection of dᵣₑₗ<s_{hazard}+b_{hazard}, and/or during a braking process of the bicycle, wherein
s_{hazard} is a hazard braking distance of the vehicle, and
b_{hazard} is a safety buffer for the normal braking distance of the vehicle,
the lighting pulsates or flashes.
   In particular, it is possible for the presence of the braking process to be detected, for example by means of a sensor. For example, the braking process can be detected by a sensor that detects the actuation of the brake trigger, e.g. the actuation of the brake lever, and/or by an acceleration sensor that detects the acceleration of the bicycle. In particular, the completion and/or absence of a braking process can also be detected. When changing from state iii. to state iv. the lighting pulsates or flashes. When changing from state iv. to state iii. the lighting intensity is set to I₂. When flashing, the lighting is preferably switched off temporarily so that no light is emitted temporarily. Instead of pulsing or flashing, it is also possible, for example, for the lighting to change to an even brighter intensity I₃ than the bright intensity I₂ when the bicycle brakes and/or when dᵣₑₗ<s_{hazard}+b_{hazard} is detected.

It is preferable that when the detected vehicle closest to the bicycle changes to another vehicle that then corresponds to the vehicle closest to the bicycle, the intensity of the lighting changes, in particular in the short time. z. For example, when overtaking the next vehicle, another vehicle driving behind the bicycle may then correspond to the new closest vehicle to be detected. To warn this vehicle, it is preferable that the intensity of the lighting is changed, particularly in the short term.

Preferably, the method comprises the further step of: detecting whether one or more vehicles are driving behind the bicycle (xᵥₑₕ=true). The detection of whether one or more vehicles are driving behind the bicycle includes in particular the detection of whether at least one vehicle is driving behind the bicycle at a distance of max. 300 m (e.g. dᵣₑₗ≥300 m), preferably max. 200 m (e.g. dᵣₑₗ≥200 m), particularly preferably max. 100 m (e.g. dᵣₑₗ≥100 m). If a vehicle is not detected behind the bicycle (xᵥₑₕ=false), it is preferred that a lighting intensity of I₁ is set. In particular, the method also includes the step of detecting the closest vehicle behind the bicycle.

It is preferred that the method comprises that if one or more of the following states are present, a corresponding illumination takes place:

| State | Lighting |
|---|---|
| dᵣₑₗ ≥ sₙₒᵣₘ + bₙₒᵣₘ | intensity I₁ |
| xᵥₑₕ = false | intensity I₁ |
| dᵣₑₗ < sₙₒᵣₘ + bₙₒᵣₘ | intensity I₂ |
| dᵣₑₗ < sₙₒᵣₘ + bₙₒᵣₘ AND dᵣₑₗ ≥ s_{hazard} + | intensity I₂ |
| b_{hazard} | |
| dᵣₑₗ < s_{hazard} + b_{hazard} | pulsing or flashing; or |
| | intensity I₃ |
| x_{break} = true AND | intensity I₂ |
| lighting intensity = I₁; and/or | |
| x_{break} = true AND | |
| dᵣₑₗ ≥ sₙₒᵣₘ + bₙₒᵣₘ; and/or | |
| x_{break} = true AND | |
| xᵥₑₕ = false | |
| x_{break} = true AND | intensity I₁ → Δt → |
| lighting intensity = I₂; and/or | intensity I₂; or |
| x_{break} = true AND | intensity I₃ |
| dᵣₑₗ < sₙₒᵣₘ + bₙₒᵣₘ AND dᵣₑₗ ≥ s_{hazard} + | |
| b_{hazard} | |
| x_{break} = false AND | intensity I₁ |
| dᵣₑₗ ≥ sₙₒᵣₘ + bₙₒᵣₘ; and/or | |
| x_{break} = false AND | |
| xᵥₑₕ = false | |
| x_{break} = false AND dᵣₑₗ < sₙₒᵣₘ + bₙₒᵣₘ | intensity I₂ |
| AND dᵣₑₗ ≥ s_{hazard} + b_{hazard} | |
| change of the detected closest vehicle | intensity I₁ |
| AND | |
| lighting intensity = I₂ | |

In particular, one or more of the above conditions may be implemented in the method, wherein an alternative or cumulative combination (and/or) of the conditions is possible. For example, the intensity I₁ can be set if dᵣₑₗ≥sₙₒᵣₘ+bₙₒᵣₘ and/or xᵥₑₕ=false, so that the following condition results, for example: IF dᵣₑₗ≥sₙₒᵣₘ+bₙₒᵣₘ THEN intensity I₁; or IF xᵥₑₕ=false THEN intensity I₁; or IF dᵣₑₗ≥sₙₒᵣₘ+bₙₒᵣₘ AND xᵥₑₕ=false THEN intensity I₁.

It is preferred that the detection device detects the lateral distance between the vehicle's lane and the bicycle's lane and/or the lateral distance between the vehicle and the bicycle. In particular, the method can include adjusting or not adjusting the intensity of the lighting based on the lateral distance detected. If, for example, the vehicle has a sufficient lateral distance, there is no need to warn the vehicle by changing the intensity. It is preferred that the angle of the lanes to each other and/or the angle between the vehicle and the bicycle is detected. In particular, the vehicle's lane has a width that corresponds to the width of the vehicle. In particular, the lane of the bicycle has a width that corresponds to the width of the bicycle. The bicycle width is in particular a fixed value, e.g. between 1.5 and 0.5 m. If the angle is 0°, for example, this means that the vehicle is traveling exactly behind the bicycle. A different angle, in particular an angle >0° or >1° or >3° and/or <0° or <−1° or <−3°, preferably in combination with a relative distance, means that the vehicle can overtake with sufficient lateral distance to the bicycle, wherein in particular the intensity of the lighting does not change. If, for example, (dᵣₑₗ*tg(θ))−(widthᵥₑₕ:2)−(width_{bike}:2)>2 m or 1.5 m applies, where θ is the angle of the lanes to each other and/or the angle between vehicle and bicycle, widthᵥₑₕ is the width of the vehicle and width_{bike} is the width of the bicycle, there is no change in the intensity of the lighting.

It is preferred that the intensity of the lighting does not change when a distance between the lanes≥a minimum distance, in particular 2 m or 1.5 m, is detected. In particular, it is possible to change the vehicle closest to the detected distance based on the detected lateral distance, in particular 2 m or 1.5 m.

It is preferred that the method comprises the further step of transmitting the detected position, preferably to the user of the bicycle. In particular, the detected position is transmitted to a mobile device of the user and/or to a handlebar feedback system of the bicycle. The mobile device is, for example, a smartwatch or a cell phone. The handlebar feedback system is, for example, a feedback system that is connected to the handlebar, in particular at least one grip, of the bicycle, preferably integrated into it. The feedback system and/or the mobile device provides acoustic and/or visual and/or haptic feedback based on the transmitted position. In particular, it is possible that the feedback to the cyclist is based on the same principle as for activating the light. For example, the cyclist can be warned if a vehicle is driving behind the bicycle with dᵣₑₗ<sₙₒᵣₘ+bₙₒᵣₘ and/or cannot maintain the lateral distance when overtaking. Preferably, feedback is given to the cyclist when a light with intensity I₂ and/or with intensity I₃ and/or pulsing and/or flashing is emitted.

It is preferred that the detection device for detecting the position of the vehicle has at least one sensor, such as a radar sensor, an ultrasonic sensor, a lidar sensor, a camera and/or an infrared sensor. The at least one sensor is preferably configured to detect the distance, and particularly preferably the change in distance, between the bicycle and the vehicle. In particular, it is also possible for the detection device to detect the velocity of the bicycle v_{bike}, e.g. by means of the at least one sensor. For example, the velocity of the bicycle relative to the ground can be detected with the detection device. In particular, the velocity of the vehicle vᵥₑₕ can be determined via the change in distance and the velocity of the bicycle v_{bike}.

The invention further comprises a system for data processing, comprising means for carrying out the method according to the invention. In particular, the data processing system comprises or consists of a processor.

The invention further comprises a warning light device for a bicycle. The warning light device has a detection device for detecting the position of a vehicle traveling behind the bicycle relative to the bicycle. Furthermore, the warning light device has a control unit which is configured to change the intensity of a light emitted by the bicycle, in particular the rear light, based on the detected position. In particular, the control unit is a data processing system according to the invention. Preferably, the warning light device has a lamp, in particular a rear lamp, to emit the light. The warning light device is configured in particular for mounting, preferably detachable mounting, to the bicycle.

It is preferred that the warning light device also has a housing, wherein the detection device, the control unit and optionally the light are arranged at least partially, in particular completely, in the housing. Preferably, the housing is configured for mounting to the bicycle, in particular detachable mounting, so that the warning light device can be connected to the bicycle by means of the mountable housing. The warning light device, in particular the housing, preferably has a fixing device for mounting the warning light device to the bicycle. In particular, the fixing device can have a quick-release fastener. For example, the fixing device has a belt, a strap, a clamp and/or a magnet. In particular, it is possible for the light and the housing to be designed as separate components, e.g. as two separate modules. For example, the lamp, in particular the rear lamp, can be used as an independent unit, in particular with a braking function. In particular, the lamp has an input to receive information from the control unit.

The invention further comprises a bicycle with a warning light device according to the invention. The warning light device, in particular the housing, is connected, e.g. detachably, to the bicycle, preferably a frame element of the bicycle, or is integrated into a frame element of the bicycle. The frame element is in particular the seat post, the seat stay, the saddle tube, the mudguard or the pannier rack of the bicycle. It is preferred that the warning light device is connected to the bicycle in such a way that the warning light device emits a rearward-facing light, in particular a rear light.

The invention further comprises a computer program comprising instructions which, when the program is executed by a computer, cause the computer to perform the method according to the invention.

The invention further comprises a computer-readable storage medium, wherein the storage medium comprises instructions which, when executed by a computer, cause the computer to perform the method according to the invention, and/or the computer program according to the invention is stored on the storage medium.

It is preferred that one or more objects according to the invention, i.e. in particular the method, the data processing system, the warning light device, the bicycle, the computer program and/or the computer-readable storage medium and, each have one or more features of the other objects according to the invention.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying drawings.

In the Figures:

FIG. 1 shows a schematic, lateral illustration of a part of an embodiment of a bicycle according to the invention with an embodiment of a warning light device according to the invention,

FIGS. 2a-c show a schematic illustration of an embodiment of a bicycle according to the invention, and

FIG. 3 shows a diagram illustrating one embodiment of a method according to the invention.

### DESCRIPTION OF THE INVENTION

Identical or similar elements are identified in the figures with the same reference numerals, although reference numerals for the respective elements are not provided in all figures.

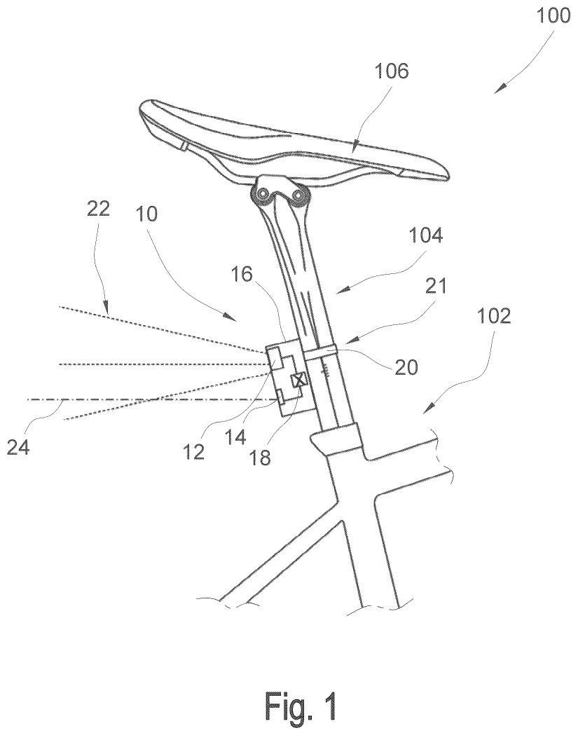

FIG. 1 shows a part of an embodiment of a bicycle 100 according to the invention with a bicycle frame 102.

An embodiment of a warning light device 10 according to the invention is connected to the seat post 104 of the saddle 106. The warning light device 10 is connected to the seat post 104 by means of a fixing device 21 connected to a housing 16 of the warning light device 10 and having a strap 20.

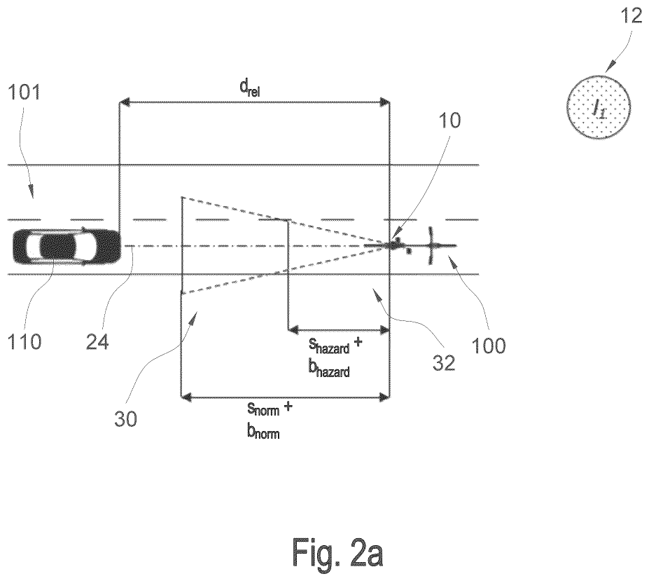

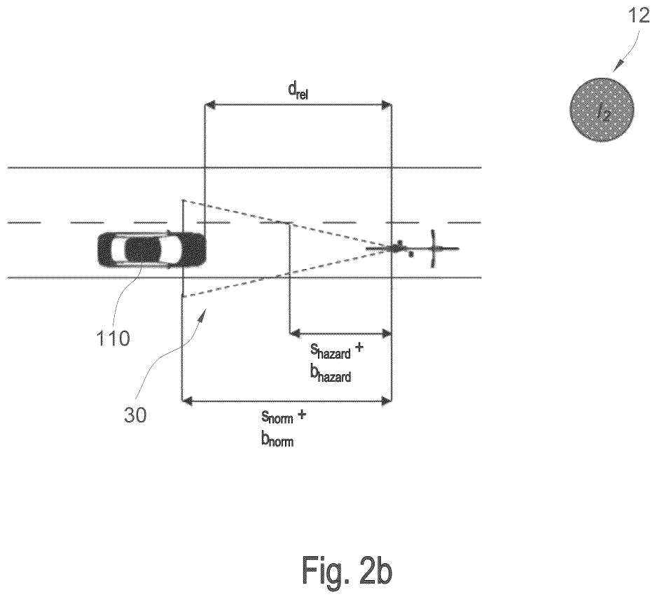

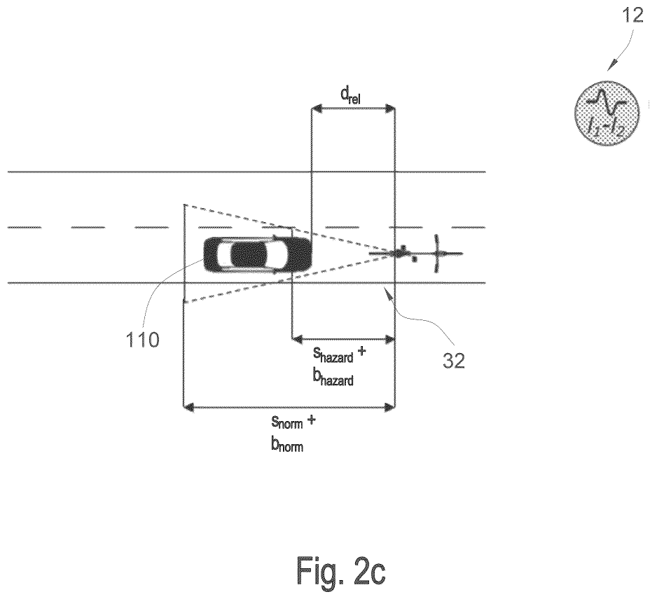

The warning light device 10 further comprises a light 12 integrated in the housing 16 for emitting a rear light 22, a detection device 14 for detecting a vehicle 110 driving behind the bicycle 100 (see FIGS. 2a-c) and a control unit 18 connected to the lamp 12 and the detection device 14 for control.

The lamp 12 can have an LED, for example. The lamp preferably emits red light 22. The lamp 12 is configured to emit several light intensities. In particular, the light 12 can emit at least light with a darker light intensity I₁ and a brighter light intensity I₂. The lamp 12 preferably has a dimming function.

The detection device 14 is configured to detect a relative distance dᵣₑₗ of a vehicle 110 driving behind the bicycle 100 (see FIGS. 2a-c) and, in particular, to detect a change in distance. The change in distance can be used to determine a relative speed vᵣₑₗ between the bicycle 100 and the following vehicle 110, for example by means of the control unit 18. Optionally, the velocity of the bicycle v_{bike} can also be detected, for example by means of the detection device 14. Preferably, the detection device 14 has a radar sensor, an ultrasonic sensor, a lidar sensor, a camera and/or an infrared sensor for detecting the distance, particularly preferably the change in distance, and preferably for detecting the velocity of the bicycle v_{bike}. For example, a radar or lidar sensor can detect the velocity of the bicycle relative to the ground, e.g. the road 101 (see FIG. 2a). The measurement signals 24, e.g. radar and/or laser beams, of the detection device 14 for detecting the vehicle 110 following the bicycle 100 are shown schematically with line 24.

FIG. 2a shows a bicycle 100, e.g. configured according to FIG. 1, with a warning light device 10, e.g. configured according to FIG. 1. The lighting state of the lamp 12, which emits the rear light of the bicycle 100, is shown at the top right for clarity.

The relative distance dᵣₑₗ between the bicycle 100 and the following vehicle 110 is detected by means of the detection device 14.

In the initial state, the warning light device 10 is set up in particular to emit a rear light with the darker light intensity I₁.

Shown in FIG. 2a, the relative distance dᵣₑₗ is greater than the normal braking distance of the vehicle 110 sₙₒᵣₘ plus a safety buffer bₙₒᵣₘ for the normal braking distance of the vehicle 110 (dᵣₑₗ≥sₙₒᵣₘ+bₙₒᵣₘ). Here, the lamp 12 also emits rear light 22 with the darker light intensity I₁. In particular, the lamp 12 thus emits a light 22 that corresponds to a standard rear light.

A preferred implementation is that when the bicycle 100 brakes in the position state shown in FIG. 2a, light 22 is emitted by the lamp 12 with the brighter light intensity I₂ in order to indicate braking. When the braking process is completed, the light intensity is reset, preferably to light intensity I₁.

FIG. 2b shows a position state, wherein dᵣₑₗ<sₙₒᵣₘ+bₙₒᵣₘ, but dᵣₑₗ is greater than the hazard braking distance of the vehicle 110 s_{hazard} plus a safety buffer b_{hazard} for the hazard braking distance of the vehicle 110 (dᵣₑₗ≥s_{hazard}+b_{hazard}). The lamp 12 emits rear light 22 with the brighter light intensity I₂. Consequently, the light emitted with increased intensity I₂ issues a warning to the vehicle 110.

The preferred implementation is that when the bicycle 100 brakes in the position state shown in FIG. 2b, the light emitted by the lamp 12 is briefly changed for Δt, for example 0.3 s, from the brighter light intensity I₂ to the darker light intensity I₁. After Δt, light with intensity I₂ is emitted again. This brief darkening and subsequent intensification means in particular that a brake warning function is implemented again.

FIG. 2c shows a positional state, wherein dᵣₑₗ<sₙₒᵣₘ+bₙₒᵣₘ and wherein dᵣₑₗ<s_{hazard}+b_{hazard}. As the vehicle 110 is therefore so close to the bicycle that the hazard braking distance plus buffer is undercut, there is an increased risk that it will no longer be possible for the vehicle 110 to brake in time. The lamp 12 emits rear light 22 with a pulsing between bright light intensity I₂ and darker light intensity I₁, or a flashing. This allows the vehicle 110 to be clearly warned.

If the vehicle 110 is moving at a velocity of 50 km/h, for example, the following applies in particular:

$${s}_{norm} = ( 50 : 10 ) \times ( 50 : 10 ) = 25 m , and$$

$${s}_{hazard} = ( ( 50 : 10 ) \times ( 50 : 10 ) ) / 2 = 12.5 m .$$

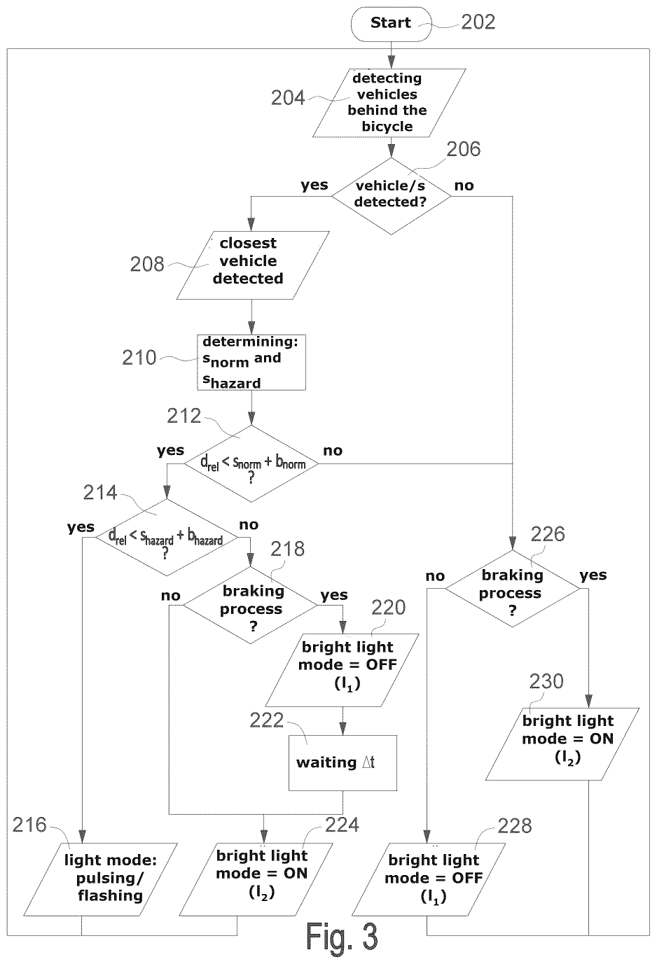

FIG. 3 shows a diagram illustrating a preferred embodiment of a method according to the invention.

Preferably, at the start of the method, a rearward-facing lighting with a darker intensity I₁ is emitted as a rear light for the bicycle 100 (see, for example, FIG. 1 or 2a-c) (start 202).

Vehicles 110 traveling behind the bicycle 100 are detected by means of a detection device 14 arranged on the bicycle 100 (step 204).

Then it is determined whether at least one vehicle 110 has been detected (step 206).

If this is the case, the closest vehicle 110 is detected (step 208) and sₙₒᵣₘ and s_{hazard} are determined for this vehicle 110 (step 210).

In the next step (step 212), it is determined whether the relative distance dᵣₑₗ of a vehicle 110 traveling behind the bicycle 100 is <sₙₒᵣₘ+bₙₒᵣₘ, wherein bₙₒᵣₘ is a safety buffer for the normal braking distance of the vehicle 110.

If dᵣₑₗ<sₙₒᵣₘ+bₙₒᵣₘ, the next step (step 214) is to determine whether the relative distance dᵣₑₗ of the vehicle 110 traveling behind the bicycle 100 is <s_{hazard}+b_{hazard}, wherein b_{hazard} is a safety buffer for the hazard braking distance of the vehicle 110.

If dᵣₑₗ<s_{hazard}+b_{hazard}, pulsing lighting is emitted, in particular alternating between the darker light intensity I₁ and the brighter light intensity I₂ (step 216). As an alternative to pulsing, the lighting may in particular flash or the lighting may have an even brighter intensity I₃ than the bright intensity I₂.

However, if it was determined in step 214 that dᵣₑₗ≥s_{hazard}+b_{hazard}, it is determined whether the bicycle 100 brakes (step 218).

When the bicycle 100 brakes, for example when the actuation of the brake lever is detected, the light intensity I₁ is briefly set (step 220) for a time Δt (step 222) and then changed to light intensity I₂ (step 224). As an alternative to the short-term setting of light intensity I₁ and subsequent light intensity I₂, lighting with an even brighter intensity I₃ than the bright intensity I₂ can also be set.

Even if it was determined in step 218 that there is no braking process, light intensity I₂ is set.

If no vehicle 110 traveling behind the bicycle 100 was detected in step 206 or if it was determined in step 212 that dᵣₑₗ≥sₙₒᵣₘ+bₙₒᵣₘ, it is determined whether the bicycle 100 is braking (step 226).

When the bicycle 100 brakes, the light intensity I₂ is set (step 230). If there is no braking process, the light intensity I₁ is set (step 228).

The warning light device 10 of FIG. 1 is particularly configured to carry out one or more method steps according to FIGS. 2a-c and/or according to FIG. 3. The method of FIG. 3 is carried out in particular with a warning light device 10 from FIG. 1 or FIGS. 2a-c.

1. A method for warning lighting on a bicycle, comprising the steps of:
detecting a position of a vehicle traveling behind the bicycle relative to the bicycle using a detection device arranged on the bicycle, and
changing the intensity of a rearward-facing lighting on the bicycle based on the detected position.

2. The method according to claim 1, wherein, when the intensity is changed, the lighting is changed from a bright to a darker lighting intensity or from a dark to a brighter lighting intensity.

3. The method according to claim 1, wherein the detection device detects the velocity vᵥₑₕ of the vehicle, the velocity v_{bike} of the bicycle and/or a relative speed vᵣₑₗ between the bicycle and the vehicle.

4. The method according to claim 1, wherein the detection device detects the relative distance dᵣₑₗ between the vehicle and the bicycle and preferably a change in distance.

5. The method according to claim 4, wherein when a change is detected between dᵣₑₗ≥sₙₒᵣₘ+bₙₒᵣₘ und dᵣₑₗ<sₙₒᵣₘ+bₙₒᵣₘ,
there is a change in the intensity of the lighting, wherein
sₙₒᵣₘ is a normal braking distance of the vehicle, and
bₙₒᵣₘ is a safety buffer for the normal braking distance of the vehicle.

6. The method according to claim 4, wherein when a change is detected between dᵣₑₗ≥s_{hazard}+b_{hazard} und dᵣₑₗ<s_{hazard}+b_{hazard},
there is a change in the intensity of the lighting, wherein
s_{hazard} is a hazard braking distance of the vehicle, and
b_{hazard} is a safety buffer for the normal braking distance of the vehicle.

7. The method according to claim 1, wherein when the bicycle is braked, the intensity of the lighting is changed, in particular in the short term.

8. The method according to claim 1, wherein during a detection of dᵣₑₗ<s_{hazard}+b_{hazard} and/or during a braking process of the bicycle, wherein
s_{hazard} is a hazard braking distance of the vehicle, and
b_{hazard} is a safety buffer for the normal braking distance of the vehicle,
the lighting pulsates.

9. The method according to claim 1, wherein the detection device detects the lateral distance of the lane of the vehicle to the lane of the bicycle.

10. The method according to claim 9, wherein the intensity of the lighting does not change when a distance between the lanes≥a minimum distance, in particular 2 m or 1.5 m, is detected.

11. The method according to claim 1, wherein the method comprises the further step of transmitting the detected position, preferably to the user of the bicycle.

12. The method according to claim 1, wherein the detection device for detecting the position of the vehicle comprises a radar sensor, ultrasonic sensor, a lidar sensor, a camera, and/or an infrared sensor.

13. A system for data processing, comprising means for carrying out the method according to claim 1.

14. A warning light device for a bicycle, comprising
a detecting device for detecting a position of a vehicle traveling behind the bicycle relative to the bicycle, and
a control unit comprising a system for data processing according to claim 13, which is configured to change the intensity of a light emitted by the bicycle based on the detected position.

15. The warning light device according to claim 14, wherein the warning light device further comprises a housing, wherein the detection device, the control unit and, in particular, a lamp for emitting the light are arranged, at least partially, in the housing.

16. A bicycle comprising a warning light device according to claim 14, wherein the warning light device is connected to the bicycle or is integrated into a frame element of the bicycle.

17. A computer program product comprising instructions which, when the program is executed by a computer, cause the computer to perform the method according to claim 1.

18. A computer-readable storage medium, wherein the storage medium comprises instructions which, when executed by a computer, cause the computer to perform the method according to claim 1.
